(19) United States
(12) Patent Application Publication
(10) Pub. No.: US 2015/0153776 A1
(43) Pub. Date: Jun. 4, 2015

(54) SCREEN PROTECTION DEVICE FOR PROTECTING DISPLAY SCREEN OF ELECTRONIC APPARATUS

(71) Applicant: Uniproo Inc., Bade City (TW)

(72) Inventors: Kuo-Liang CHENG, New Taipei City (TW); Chun-Hung SU, New Taipei City (TW)

(73) Assignee: Uniproo Inc., Bade City (TW)

(21) Appl. No.: 14/539,759

(22) Filed: Nov. 12, 2014

Related U.S. Application Data
(63) Continuation-in-part of application No. 14/093,850, filed on Dec. 2, 2013.

(30) Foreign Application Priority Data
Oct. 31, 2014 (TW) 103219408

(51) Int. Cl. G06F 1/16; G06F 3/041

(52) U.S. Cl. CPC G06F 1/1637; G06F 3/0412

(57) ABSTRACT

A screen protection device for protecting a display screen of an electronic apparatus includes: a tempered glass sheet, a mask layer, an optical clear adhesive layer, and an adhesive layer. The mask layer is positioned on the tempered glass sheet and defines a transparent region for the screen protection device. The optical clear adhesive layer is positioned on the tempered glass sheet and covers the transparent region, but does not cover the mask layer. The adhesive layer is positioned on the mask layer and the optical clear adhesive layer, and is utilized for detachably attaching to the display screen of the electronic apparatus. A thickness of the optical clear adhesive layer is at least 80% of a thickness of the mask layer.

### CROSS-REFERENCE TO RELATED APPLICATIONS

This application is a Continuation-In-Part of and claims the benefit of priority to U.S. patent application Ser. No. 14/093,850, filed on Dec. 2, 2013; the entirety of which is incorporated herein by reference for all purposes.

This application claims the benefit of priority to Patent Application No. 103219408, filed in Taiwan on Oct. 31, 2014; the entirety of which is incorporated herein by reference for all purposes.

### BACKGROUND

The present disclosure generally relates to a screen protection device and, more particularly, to a screen protection device for avoiding a display screen of an electronic apparatus from the phenomenon of Newton's rings.

To prevent a touch screen of an electronic apparatus from being scratched or smudged, many people choose to attach a screen protection sheet on a surface of the touch screen to protect the touch screen.

U.S. Pat. No. 8,044,942 discloses a kind of screen protector to avoid air bubbles between the screen protector and the surface of the touch screen. The screen protector disclosed in the U.S. Pat. No. 8,044,942 includes a plastic film having an outer perimeter and a transparent window; and a spacer provided along the outer perimeter of the plastic film surrounding the transparent window and having a thickness sufficient to space the plastic film near but not in contact with the touch screen portion; and an exposed adhesive for mounting the screen protector upon an outer perimeter of the touch screen to form an enclosed air space between the transparent window, the spacer, and the touch screen.

However, after multiple times of pressing the afore-mentioned screen protector, the transparent window of the screen protector deforms and becomes sunken because the amount of air in the enclosed air space reduces. Once the screen protector becomes sunken, when the light passes through the transparent window and the touch screen, the reflected light of the transparent window and the reflected light of the touch screen form interference fringes. In this situation, multiple circular fringes arranged concentrically on the touch screen will be perceived by the user. This phenomenon is also known as Newton's rings. The presence of the Newton's rings would interfere with the images displayed by the touch screen and degrade the visual effect of the images and may even cause discomfort to human eyes.

### SUMMARY

An example embodiment of a screen protection device for protecting a display screen of an electronic apparatus is disclosed. The screen protection device comprises: a tempered glass sheet having a first surface and a second surface; a mask layer positioned on the first surface of the tempered glass sheet and defining a transparent area for the screen protection device, wherein the transparent area has a shape corresponding to the display screen of the electronic apparatus; an optical clear adhesive (OCA) layer positioned on the first surface of the tempered glass sheet, covering the transparent area, but not covering the mask layer; and an adhesive layer positioned on the mask layer and the OCA layer, and utilized for detachably attaching to the display screen of the electronic apparatus; wherein a thickness of the OCA layer is at least 80% of a thickness of the mask layer.

Another example embodiment of a screen protection device for protecting a display screen of an electronic apparatus is disclosed. The screen protection device comprises: a tempered glass sheet having a first surface and a second surface, wherein the tempered glass sheet has a thickness ranging from 0.2 to 0.4 millimeter; a mask layer positioned on the first surface of the tempered glass sheet and defining a transparent area for the screen protection device, wherein the transparent area has a shape corresponding to the display screen of the electronic apparatus; a harden layer positioned on the second surface of the tempered glass sheet to protect the second surface of the tempered glass sheet; an optical clear adhesive (OCA) layer positioned on the first surface of the tempered glass sheet, covering the transparent area, but not covering the mask layer, wherein the OCA layer has a diagonal greater than 5 inches, and a thickness of the OCA layer is at least 80% of a thickness of the mask layer; an adhesive layer positioned on the mask layer and the OCA layer, and utilized for detachably attaching to the display screen of the electronic apparatus, wherein the adhesive layer has a thickness less than a thickness of the mask layer, and a total surface area of the adhesive layer is less than or equal to a sum of a total surface area of the mask layer and a total surface area of the OCA layer; and an annular protruding structure positioned on the mask layer and surrounding the adhesive layer, wherein a height of the annular protruding structure is greater than a thickness of the adhesive layer, and when the adhesive layer is attached onto the display screen of the electronic apparatus, an outer surface of the annular protruding structure is attached to a peripheral region of the display screen.

Both the foregoing general description and the following detailed description are examples and explanatory only, and are not restrictive of the invention as claimed.

### BRIEF DESCRIPTION OF THE DRAWINGS

FIG. 1 shows a schematic front view diagram of a screen protection device according to one example embodiment.

FIG. 2 shows a schematic cross-sectional diagram of the screen protection device of FIG. 1 along the direction A-A′.

FIG. 3 shows a schematic cross-sectional diagram of the screen protection device of FIG. 1 along the direction B-B′.

FIG. 4 shows a schematic cross-sectional diagram of the screen protection device of FIG. 1 along the direction C-C′.

FIG. 5 shows a schematic front view diagram of a screen protection device according to another example embodiment.

FIG. 6 and FIG. 7 show schematic cross-sectional diagrams of the screen protection device of FIG. 5 along the direction D-D′.

FIG. 8 shows a schematic cross-sectional diagram of the screen protection device of FIG. 5 along the direction E-E′.

FIG. 9 shows a schematic cross-sectional diagram of the screen protection device of FIG. 5 along the direction F-F′.

### DETAILED DESCRIPTION

Reference is made in detail to embodiments of the invention, which are illustrated in the accompanying drawings. The same reference numbers may be used throughout the drawings to refer to the same or like parts, components, or operations.

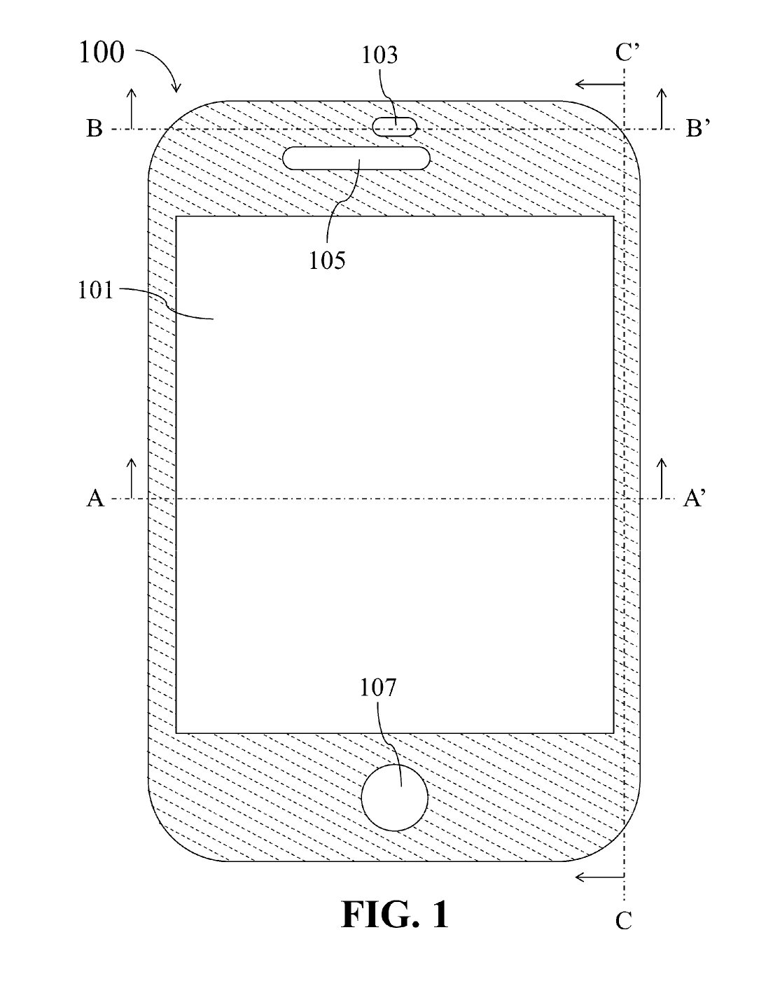

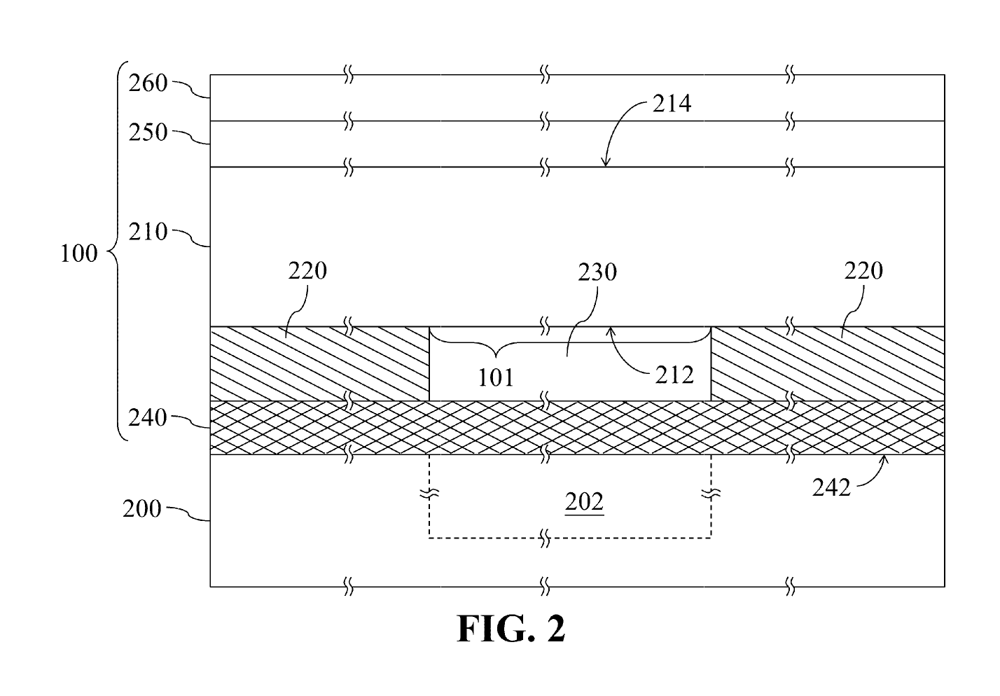

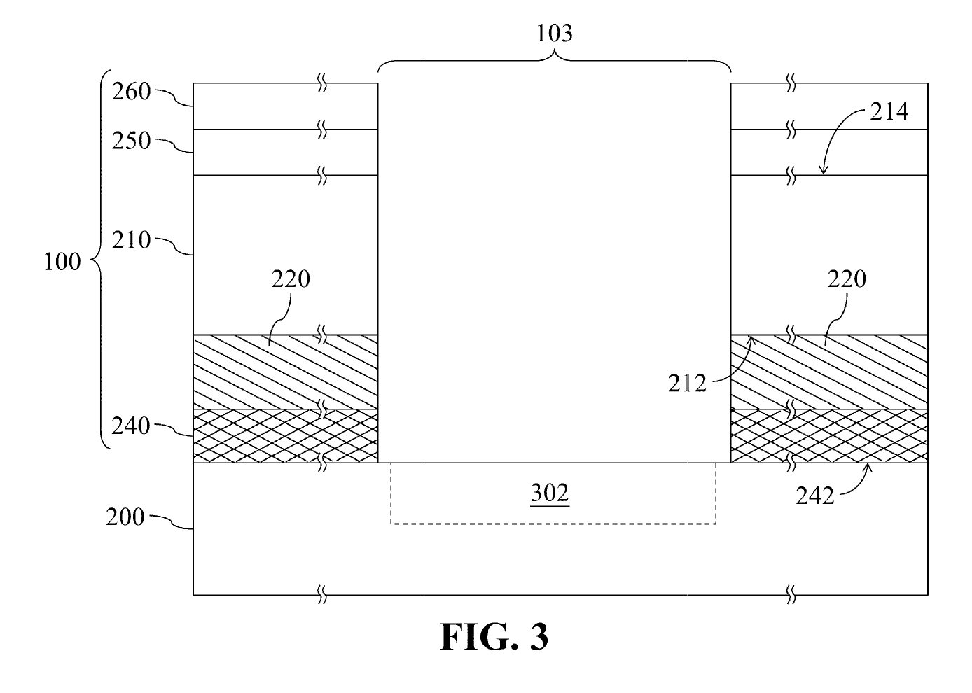

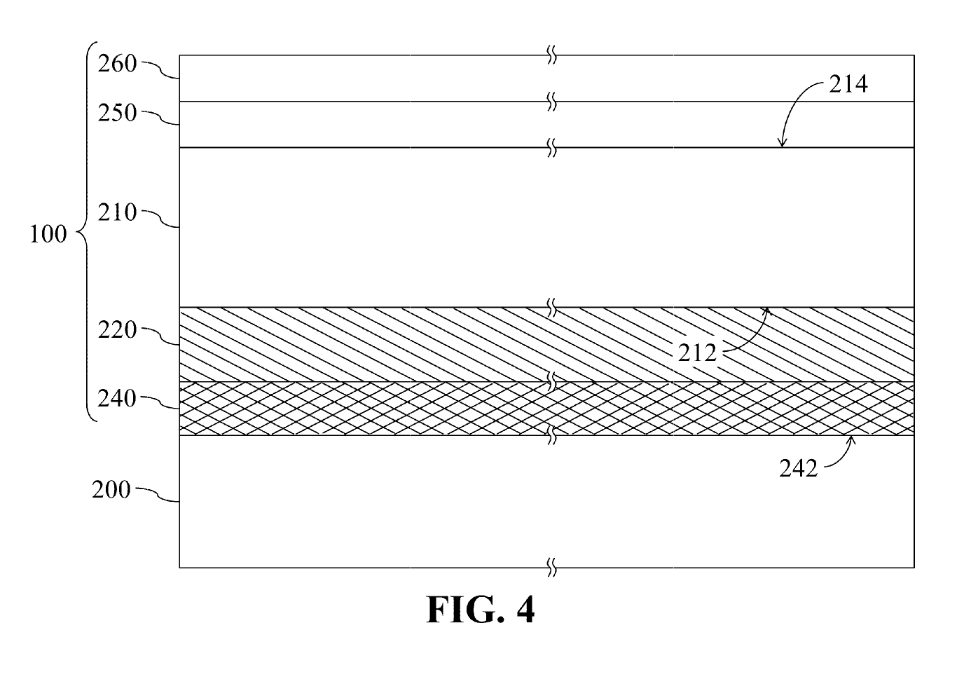

Please refer to FIG. 1 to FIG. 4. FIG. 1 shows a schematic front view diagram of a screen protection device 100 in accordance with one example embodiment. FIG. 2 shows a schematic cross-sectional diagram of the screen protection device 100 along the direction A-A′ of FIG. 1. FIG. 3 shows a schematic cross-sectional diagram of the screen protection device 100 along the direction B-B′ of FIG. 1. FIG. 4 shows a schematic cross-sectional diagram of the screen protection device 100 along the direction C-C′ of FIG. 1. The screen protection device 100 may be utilized for attaching onto a surface of an electronic apparatus 200 to avoid the surface of a display screen 202 of the electronic apparatus 200 from being damaged. The electronic apparatus 200 may be any kind of electronic devices having a display screen, such as any hand-held mobile communication device (e.g., cell phone, tablet computer, or notebook computer) or may be a television, a computer screen, or any other display device.

The screen protection device 100 may be provided with one or more openings corresponding to the components on the electronic apparatus 200. In the embodiment of FIG. 1, for example, openings 103 and 105 are positioned near one end of the screen protection device 100, and an opening 107 is positioned near the other end of the screen protection device 100. The openings 103, 105, and 107 are respectively positioned corresponding to a front-end camera, an earphone, or a control button of the electronic apparatus 200 to avoid the previous elements from being blocked by the screen protection device 100. When the user wants to attach the screen protection device 100 onto the electronic apparatus 200, the openings 103, 105, and 107 may be utilized as an alignment basis so that the user can accurately attach the screen protection device 100 onto the electronic apparatus 200.

As shown in FIG. 2 through FIG. 4, the screen protection device 100 of this embodiment comprises a tempered glass sheet 210, a mask layer 220, an optical clear adhesive (OCA) layer 230, an adhesive layer 240, a harden layer 250, and an antibacterial layer 260.

The tempered glass sheet 210 is utilized as a main body of the screen protection device 100, and has a thickness ranging from 0.2 to 0.4 millimeter, such as 0.3 millimeter. The tempered glass sheet 210 comprises a first surface 212 facing to the electronic apparatus 200 and a second surface 214 back to the electronic apparatus 200.

The mask layer 220 is positioned on the first surface 212 of the tempered glass sheet 210 and defines a transparent area 101 for the screen protection device 100. The transparent area 101 has a shape corresponding to a shape of the display screen 202 of the electronic apparatus 200, and is surrounded by the mask layer 220. The mask layer 220 may be realized by an opaque or a translucent material to mask the adhesive layer 240. In practice, for example, the mask layer 220 may be formed by printing dyes of a specific color, such as black, gray, or white, on the first surface 212 of the tempered glass sheet 210.

The OCA layer 230 is positioned on the first surface 212 of the tempered glass sheet 210 and covers the transparent area 101. When manufacturing the screen protection device 100, an optical clear adhesive may be smoothly coated on the area surrounded by the mask layer 220 (i.e., the above-mentioned transparent area 101) on the first surface 212 of the tempered glass sheet 210, and then the OCA layer 230 with supporting functionality is formed when the optical clear adhesive is cured. The aforementioned optical clear adhesive is transparent glue having light transmittance higher than 90%, and the optical clear adhesive could be cured under normal room temperature or moderate temperature and has a very small curing shrinkage.

Since the OCA layer 230 has strong stickiness, the adhesive layer 240 should not be directly attached onto the display screen 202. Otherwise, when the user wants to detach the screen protection device 100 from the surface of the electronic apparatus 200, the tempered glass sheet 210 may be easily damaged due to the bending stress applied thereon. In order to prevent the aforementioned problem, the adhesive layer 240, whose stickiness is much lower than the OCA layer 230, is placed on the mask layer 220 and the OCA layer 230. Accordingly, a total surface area of the adhesive layer 240 may be equal to a sum of a total surface area of the mask layer 220 and a total surface area of the OCA layer 230 in this embodiment. The adhesive layer 240 comprises a sticking surface 242 for detachably attaching onto the display screen 202 of the electronic apparatus 200. The adhesive layer 240 may have a thickness less than a thickness of the mask layer 220. In practice, the adhesive layer 240 may be attached onto the display screen 202 of the electronic apparatus 200 through an electrostatic adhesion manner or other adhesion approaches. With the adhesive layer 240, the screen protection device 100 may be rapidly attached onto the surface of the electronic apparatus 200 and could be easily removed from the surface of the electronic apparatus 200 without leaving any residue or trace of glue on the surface of the electronic apparatus 200. As a result, the use of the adhesive layer 240 could significantly reduce the possibility of damaging the tempered glass sheet 210 when detaching the screen protection device 100 from the surface of the electronic apparatus 200.

In practice, AB glue may be coated onto the mask layer 220 and the OCA layer 230 to form the adhesive layer 240. That is, the adhesive layer 240 may be realized with an AB glue layer.

The harden layer 250 is positioned on the second surface 214 of the tempered glass sheet 210 to protect the second surface 214. In practice, a hardening agent may be coated on the second surface 214 of the tempered glass sheet 210 to form the harden layer 250 to thereby increase the hardness of the screen protection device 100.

The antibacterial layer 260 is positioned on the harden layer 250 to reduce or avoid bacteria. In practice, an anti-fog (AF) potion or an anti-smudge (AS) potion may be coated on the harden layer 250, and then the antibacterial layer 260 is formed when the AF potion or the AS potion dries to thereby provide anti-smudge and nano-antibacterial functionalities to reduce or avoid bacteria.

As shown in FIG. 2, when the adhesive layer 240 of the screen protection device 100 is attached onto the display screen 202 of the electronic apparatus 200, the OCA layer 230 is positioned between the tempered glass sheet 210 and the adhesive layer 240 to function as a pad layer between the tempered glass sheet 210 and the display screen 202, but does not directly contact with the display screen 202. In this situation, the OCA layer 230 acts as a supporting element for supporting the tempered glass sheet 210 to avoid the tempered glass sheet 210 from deforming toward the display screen 202 due to gravity, elastic fatigue, or other issues. Therefore, with the supporting of the OCA layer 230, the electronic apparatus 200 can be effectively avoided from the phenomenon of Newton's rings.

Please note that the OCA layer 230 in the screen protection device 100 may contact with the side edges of the mask layer 220, but should not cover partial or entire upper surface of the mask layer 220. Otherwise, the resulting adhesive layer 240 may be uneven and therefore adversely affects the fitness between the screen protection device 100 and the display screen 202. Moreover, once the OCA layer 230 covers partial or entire upper surface of the mask layer 220, the thickness and weight of the entire screen protection device 100 would be inevitably increased, which is difficult to satisfy the user's demand.

Each of the afore-mentioned openings 103, 105, and 107 is positioned outside the transparent area 101 of the screen protection device 100, and thus does not passes through the OCA layer 230. However, each of the afore-mentioned openings 103, 105, and 107 penetrates the tempered glass sheet 210, the mask layer 220, and the adhesive layer 240 so as to avoid the front-end camera, the earphone, and the control button of the electronic apparatus 200 to be blocked by the tempered glass sheet 210, the mask layer 220, or the adhesive layer 240. For example, as shown in FIG. 3, when the screen protection device 100 is attached onto the surface of the electronic apparatus 200, the opening 103 of the screen protection device 100 is aligned with a front-end camera 302 of the electronic apparatus 200 so that the front-end camera 302 is allowed to successively capture images through the opening 103.

In practice, the OCA layer 230 may be dimensioned to have a size substantially the same as the size of the display screen 202. For example, in the embodiment where the display screen 202 has a diagonal of 4 inches, the OCA layer 230 may be dimensioned to have a diagonal equal to or slightly greater than 4 inches. In the embodiment where the display screen 202 has a diagonal of 5 inches, the OCA layer 230 may be dimensioned to have a diagonal equal to or slightly greater than 5 inches. In the embodiment where the display screen 202 has a diagonal of 7 inches, the OCA layer 230 may be dimensioned to have a diagonal equal to or slightly greater than 7 inches. In the embodiment where the display screen 202 has a diagonal of 11 inches, the OCA layer 230 may be dimensioned to have a diagonal equal to or slightly greater than 11 inches. In the embodiment where the display screen 202 has a diagonal of 15 inches, the OCA layer 230 may be dimensioned to have a diagonal equal to or slightly greater than 15 inches. The same design analogue applies to other embodiments.

As can be appreciated from the foregoing descriptions, the proposed screen protection device 100 is applicable to the electronic apparatus 200 of any size, and can be even applied to a variety of tablet computers or televisions equipped with a larger screen.

In order to effectively reduce the sunken degree of the transparent area 101 of the screen protection device 100, the OCA layer 230 may be designed to have a thickness which is at least 80% of a thickness of the mask layer 220. For example, the OCA layer 230 may be designed to have a thickness of 85%, 90%, 95%, or 98% of the thickness of the mask layer 220. Of course, the OCA layer 230 may be designed to have substantially the same thickness as the mask layer 220.

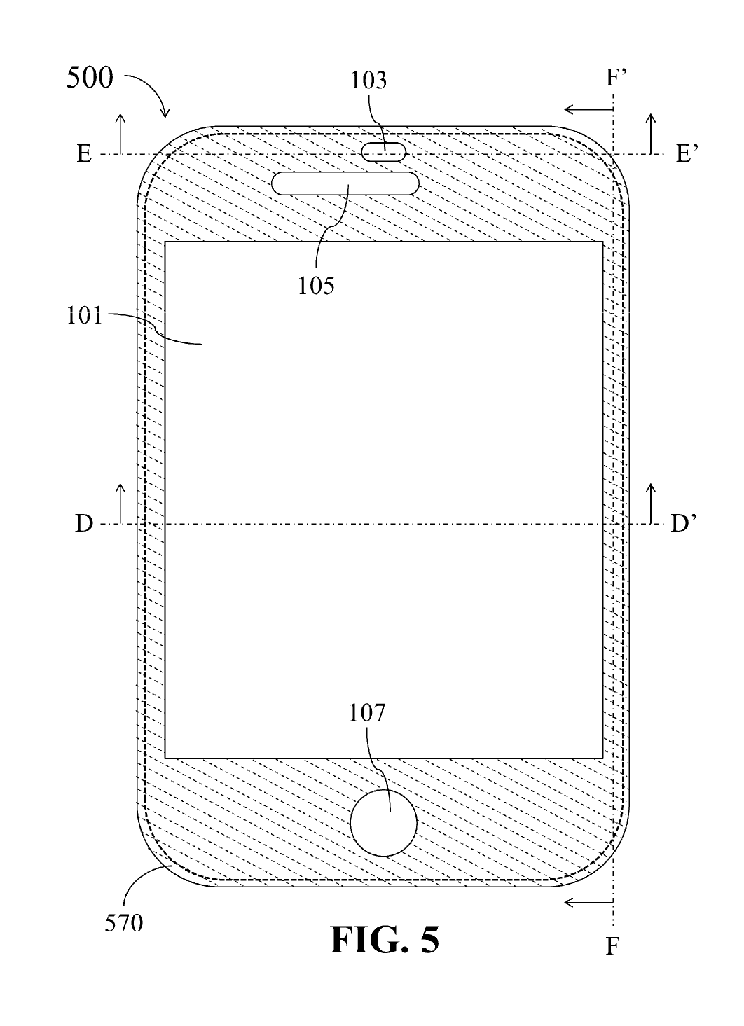

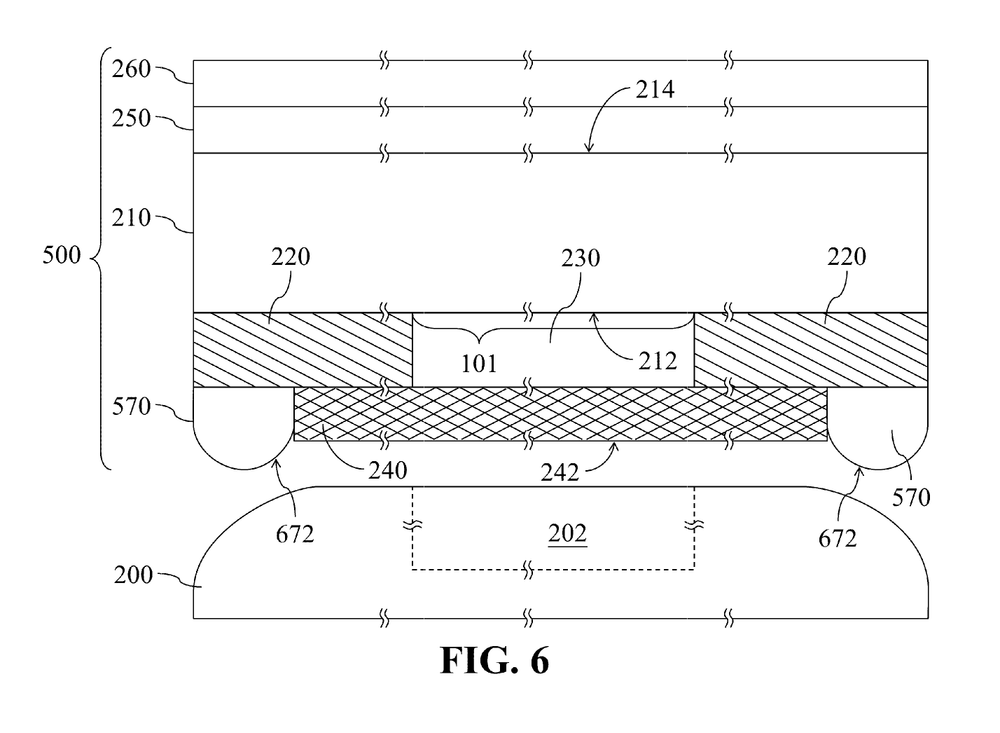

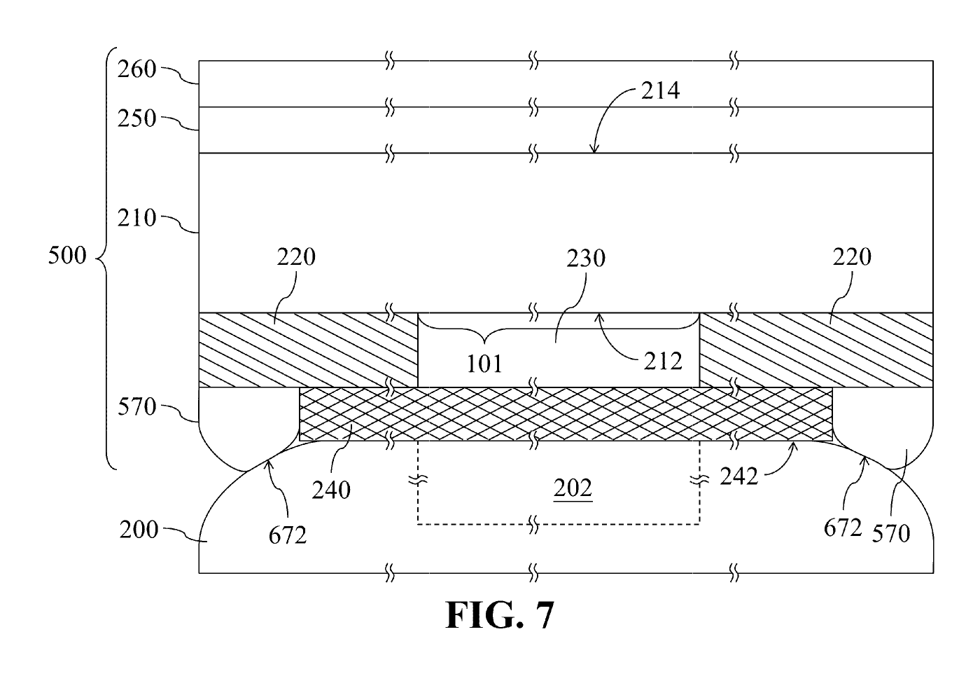

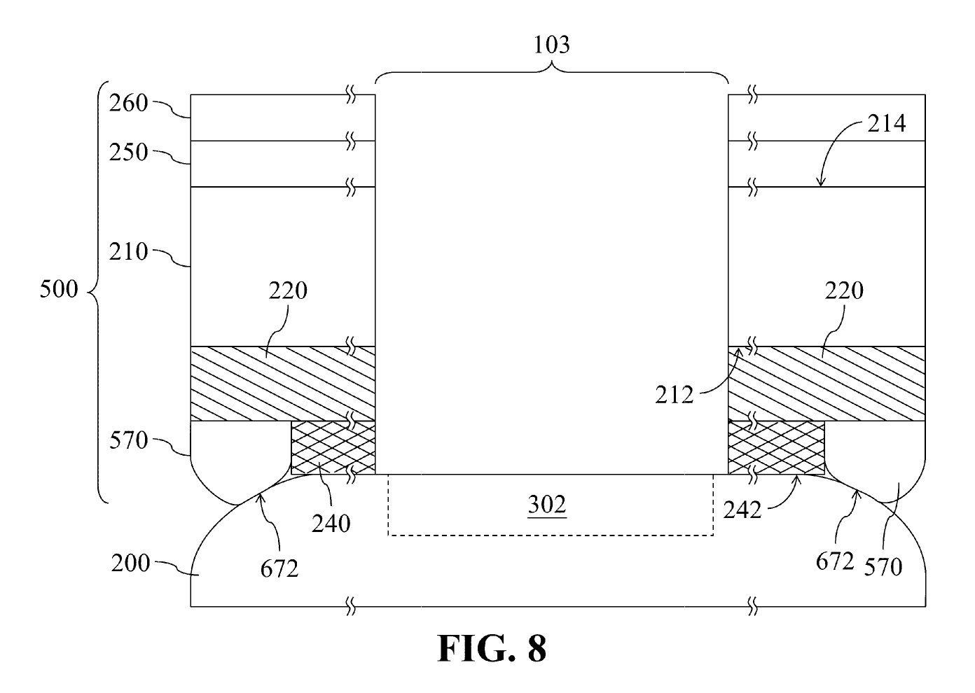

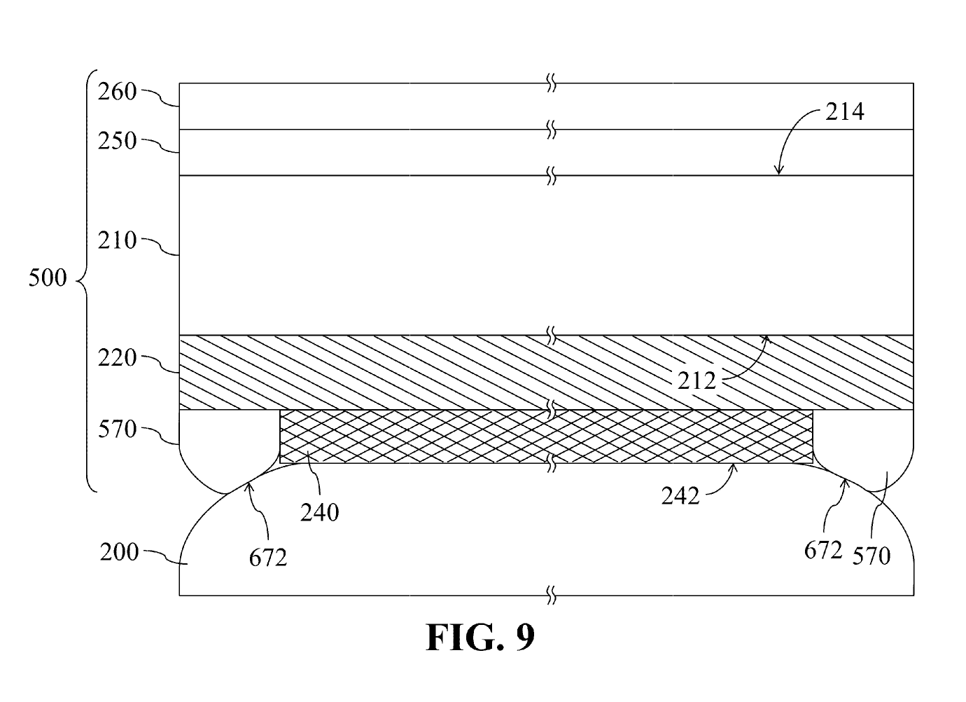

Please refer to FIG. 5 to FIG. 9. FIG. 5 shows a schematic front view diagram of a screen protection device 500 in accordance with another example embodiment. FIG. 6 and FIG. 7 show schematic cross-sectional diagrams of the screen protection device 500 along the direction D-D′ of FIG. 5. FIG. 8 shows a schematic cross-sectional diagram of the screen protection device 400 along the direction E-E′ of FIG. 5. FIG. 9 shows a schematic cross-sectional diagram of the screen protection device 500 along the direction F-F′ of FIG. 5.

The screen protection device 500 is similar to the screen protection device 100 described previously, but the screen protection device 500 is more feasible to be applied to the electronic apparatuses whose display screen 202 is designed to have a curved surface in the peripheral region. One difference between the two embodiments is that the screen protection device 500 is additionally provided with an annular protruding structure 570. Another difference between the two embodiments is that the total area of the adhesive layer 240 in the screen protection device 500 is smaller than the total area of the adhesive layer 240 in the screen protection device 100.

As shown in FIG. 5, the annular protruding structure 570 is positioned on the peripheral region of the screen protection device 500. In practice, the annular protruding structure 570 is preferably designed to have a width ranging from 0.2 to 1 millimeter, such as 0.5 millimeter.

In the embodiment illustrated in FIG. 6 through FIG. 9, the outmost peripheral region of the display screen 202 of the electronic apparatus 200 is designed to have a curved surface. As well known in the art, bending the peripheral region of the tempered glass sheet 210 to be a curved surface requires considerable manufacturing cost, but the yield rate is still too low. Therefore, even with state-of-the-art manufacturing technologies, it is still very difficult to bend the outmost peripheral region of the tempered glass sheet 210 in the screen protection device 500 to be perfectly matched with the shape of the curved surface in the outmost peripheral region of the display screen 202.

As illustrated in FIG. 6 through FIG. 9 the tempered glass sheet 210 in the screen protection device 500 also has a planar appearance. The peripheral edge of the adhesive layer 240 of the screen protection device 500 is slightly stepped back compared to the adhesive layer 240 of the screen protection device 100, so that the outmost region of the mask layer 220 is not covered by the adhesive layer 240. Accordingly, the total surface area of the adhesive layer 240 of the screen protection device 500 is slightly smaller than a sum of the total surface area of the mask layer 220 and the total surface area of the OCA layer 230, and thus the total surface area of the adhesive layer 240 of the screen protection device 500 is slightly smaller than the total surface area of the adhesive layer 240 of the screen protection device 100.

In the screen protection device 500, the annular protruding structure 570 is positioned in the outmost peripheral region of the mask layer 220 and surrounds the adhesive layer 240, and thus the side edge of the annular protruding structure 570 contacts with the side edge of the adhesive layer 240. In addition, the annular protruding structure 570 is designed to have a height apparently greater than the thickness of the adhesive layer 240. For example, the annular protruding structure 570 may be designed to have a height ranging from 150% to 400% of the thickness of the adhesive layer 240, such as 250% of the thickness of the adhesive layer 240. In practice, the annular protruding structure 570 may be realized with a soft gel with elasticity and stickiness, such as the PV gel.

Please note that because the annular protruding structure 570 is not positioned on the adhesive layer 240, the relatively-lower stickiness of the adhesive layer 240 would not cause the annular protruding structure 570 to easily peel off the adhesive layer 240.

As shown in FIG. 7 through FIG. 9, when the adhesive layer 240 of the screen protection device 500 is attached onto the display screen 202 of the electronic apparatus 200, an outer surface 672 of the annular protruding structure 570 would slightly deform and attach onto the curved surface in the outmost peripheral region of the display screen 202, so that the screen protection device 500 can be more fittingly attached onto the surface of the display screen 202 of the electronic apparatus 200. In other words, the presence of the annular protruding structure 570 effectively prevents gaps from occurring between the curved surface in the outmost peripheral region of the display screen 202 and the screen protection device 500, without significantly increasing the manufacturing cost of the screen protection device 500.

As a result, the annular protruding structure 570 not only effectively prevents the outmost peripheral region of the screen protection device 500 from damaging, but also prevents dust from jamming between the curved surface in the outmost peripheral region of the display screen 202 and the screen protection device 500. From another perspective, the presence of the annular protruding structure 570 not only improves the cosmesis of the screen protection device 500 in usage, but also effectively prolongs the lifetime of the screen protection device 500.

The foregoing descriptions regarding the implementations and related advantages of the other structures in the screen protection device 100 are also applicable to the corresponding structures in the screen protection device 500. For the sake of brevity, the same descriptions will not be repeated here.

Additionally, in some embodiments, the previous harden layer 250 and/or the antibacterial layer 260 may be omitted to further simplify the structure of the screen protection device 100 or 500.

In addition, in some embodiments where the screen protection device 100 or 500 is applied to a television or computer screen, the previous openings 103, 105, and 107 may be omitted.

As can be seen from the foregoing descriptions, when the screen protection device 100 or 500 is attached onto the display screen 202 of the electronic apparatus 200, the OCA layer 230 positioned between the tempered glass sheet 210 and the display screen 202 supports the weight of the screen protection device 100 or 500, thereby avoiding the phenomenon of Newton's rings caused by the deformation of the screen protection device 100 or 500.

Furthermore, the structure of the proposed screen protection device 100 or 500 is very simple and compact, and can effectively increase the manufacturing yield rate of the screen protection device 100 or 500.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.”

The term “and/or” may comprise any and all combinations of one or more of the associated listed items. In addition, the singular forms “a,” “an,” and “the” herein are intended to comprise the plural forms as well, unless the context clearly indicates otherwise.

Throughout the description and claims, the term “element” contains the concept of component, layer, or region.

In the drawings, the size and relative sizes of some elements may be exaggerated or simplified for clarity. Accordingly, unless the context clearly specifies, the shape, size, relative size, and relative position of each element in the drawings are illustrated merely for clarity, and not intended to be used to restrict the claim scope.

For the purpose of explanatory convenience in the specification, spatially relative terms, such as “on,” “above,” “below,” “beneath,” “higher,” “lower,” “upward,” “downward,” and the like, may be used herein to describe the function of a particular element or to describe the relationship of one element to another element(s) as illustrated in the drawings. It will be understood that the spatially relative terms are intended to encompass different orientations of the element in use, in operations, or in assembly in addition to the orientation depicted in the drawings. For example, if the element in the drawings is turned over, elements described as “on” or “above” other elements would then be oriented “under” or “beneath” the other elements. Thus, the exemplary term “beneath” can encompass both an orientation of above and beneath.

Throughout the description and claims, it will be understood that when a component is referred to as being “positioned on,” “positioned above,” “connected to,” “engaged with,” or “coupled with” another component, it can be directly on, directly connected to, or directly engaged with the other component, or intervening component may be present. In contrast, when a component is referred to as being “directly on,” “directly connected to,” or “directly engaged with” another component, there are no intervening components present.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A screen protection device for protecting a display screen of an electronic apparatus, the screen protection comprising:
a tempered glass sheet having a first surface and a second surface;
a mask layer positioned on the first surface of the tempered glass sheet and defining a transparent area for the screen protection device, wherein the transparent area has a shape corresponding to the display screen of the electronic apparatus;
an optical clear adhesive (OCA) layer positioned on the first surface of the tempered glass sheet, covering the transparent area, but not covering the mask layer; and
an adhesive layer positioned on the mask layer and the OCA layer, and utilized for detachably attaching to the display screen of the electronic apparatus;
wherein a thickness of the OCA layer is at least 80% of a thickness of the mask layer.

2. The screen protection device of claim 1, wherein a total surface area of the adhesive layer is less than or equal to a sum of a total surface area of the mask layer and a total surface area of the OCA layer.

3. The screen protection device of claim 1, wherein the OCA layer has a diagonal equal to or greater than 4 inches.

4. The screen protection device of claim 1, further comprising:
at least one opening positioned outside the transparent area of the screen protection device, and penetrating the tempered glass sheet, the mask layer, and the adhesive layer.

5. The screen protection device of claim 1, further comprising:
an annular protruding structure positioned on the mask layer and surrounding the adhesive layer;
wherein a height of the annular protruding structure is greater than a thickness of the adhesive layer, and when the adhesive layer is attached onto the display screen of the electronic apparatus, an outer surface of the annular protruding structure is attached to a peripheral region of the display screen.

6. The screen protection device of claim 5, wherein the height of the annular protruding structure ranges from 150% to 400% of the thickness of the adhesive layer.

7. The screen protection device of claim 1, further comprising:
a harden layer positioned on the second surface of the tempered glass sheet to protect the second surface of the tempered glass sheet;
wherein the tempered glass sheet has a thickness ranging from 0.2 to 0.4 millimeter.

8. The screen protection device of claim 7, further comprising:
an antibacterial layer positioned on the harden layer to reduce or avoid bacteria.

9. A screen protection device for protecting a display screen of an electronic apparatus, comprising:
a tempered glass sheet having a first surface and a second surface, wherein the tempered glass sheet has a thickness ranging from 0.2 to 0.4 millimeter;
a mask layer positioned on the first surface of the tempered glass sheet and defining a transparent area for the screen protection device, wherein the transparent area has a shape corresponding to the display screen of the electronic apparatus;
a harden layer positioned on the second surface of the tempered glass sheet to protect the second surface of the tempered glass sheet;
an optical clear adhesive (OCA) layer positioned on the first surface of the tempered glass sheet, covering the transparent area, but not covering the mask layer, wherein the OCA layer has a diagonal greater than 5 inches, and a thickness of the OCA layer is at least 80% of a thickness of the mask layer;
an adhesive layer positioned on the mask layer and the OCA layer, and utilized for detachably attaching to the display screen of the electronic apparatus, wherein the adhesive layer has a thickness less than a thickness of the mask layer, and a total surface area of the adhesive layer is less than or equal to a sum of a total surface area of the mask layer and a total surface area of the OCA layer; and
an annular protruding structure positioned on the mask layer and surrounding the adhesive layer, wherein a height of the annular protruding structure is greater than a thickness of the adhesive layer, and when the adhesive layer is attached onto the display screen of the electronic apparatus, an outer surface of the annular protruding structure is attached to a peripheral region of the display screen.

10. The screen protection device of claim 9, wherein the height of the annular protruding structure ranges from 150% to 400% of the thickness of the adhesive layer.
